(19) United States
(12) Patent Application Publication
(10) Pub. No.: US 2006/0146775 A1
(43) Pub. Date: Jul. 6, 2006

(54) Access point for ensuring quality of service of broadcasting service in wireless local area network

(75) Inventors: Kwan-Woong Song, Seongnam-si (KR); Chang-Sup Shim, Seoul (KR); Jun-Ho Koh, Suwon-si (KR); Jong-Hun Lee, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/301,597

(22) Filed: Dec. 13, 2005

(30) Foreign Application Priority Data
Dec. 31, 2004 (KR) 2004-118154

(51) Int. Cl. H04Q 7/24; H04L 12/54

(52) U.S. Cl. 370/338; 370/428

(57) ABSTRACT

An access point (AP) for ensuring a Quality of Service (QoS) of a broadcasting service in a Wireless Local Area Network (WLAN) is provided. A broadcast signal input unit receives a broadcast signal and depacketizes the received broadcast signal into a transport stream. A broadcast signal control unit receives channel selection information of a terminal, creates a zapping signal (protocol) and a control signal using bandwidth information to control a broadcast signal. A broadcast signal switching unit selectively receives the transport stream using the zapping signal, stores the received transport stream for a predetermined amount of time, and outputs the stored transport stream to the broadcast signal control unit through time slicing using the control signal.

### CLAIM OF PRIORITY

This application claims priority under 35 U.S.C. §119 to an application entitled “Access Point for Ensuring Quality of Service of Broadcasting Service in Wireless Local Area Network,” filed in the Korean Intellectual Property Office on Dec. 31, 2004 and assigned Serial No. 2004-118154, the contents of which are incorporated herein by reference.

### BACKGROUND OF THE INVENTION

1. Field of the Invention

The present invention generally relates to a Wireless Local Area Network (WLAN), and in particular, to an Access Point (AP) for ensuring the Quality of Service (QoS) of a broadcasting service.

2. Description of the Related Art

In a wired Local Area Network (LAN) environment, data is generally transmitted and received using a transmission line, such as a coaxial cable or an optical fiber. However, unlike a wired LAN, a WLAN is advantageous in that data can be transmitted and received wirelessly over the air with minimum link connections using a frequency or Infrared (IR) technique.

The WLAN is generally configured using a WLAN card or an AP. In case the WLAN is configured using an AP, the WLAN shares the network with an existing wired LAN. Hereinafter, a configuration of the WLAN using an AP will be described with reference to FIG. 1.

FIG. 1 schematically illustrates a general WLAN. As shown, the general WLAN shares a network with a wired LAN. An AP 101 connects to an external network, such as a broadcast network or the Internet, via a transmission medium, such as a satellite, a ground wave, or a cable. A WLAN user also connects to the network coupled to the wired LAN. The AP 101 acting as an independent repeater is connected to an Ethernet hub or a server to serve as a switch or a hub as in the wired LAN. The WLAN connects a wireless client, i.e., a terminal 103 within a service area of the AP 101, to the wired LAN.

The introduction of the WLAN eliminates the need for network wires and allows users to surf the Internet or exchange data anywhere, anytime. Moreover, the WLAN provides easy network scalability and various wireless network configurations, thereby making it possible to establish a network in an area that has been unsuitable. Due to various advantages including no restriction to mobility, the demand and use of the WLAN have increased.

However, a broadcasting service provided in a current network requires a large bandwidth and is of higher importance than the other services. Moreover, high-quality broadcast signals have recently become available, thus more bandwidths are required to enjoy the services. Since data is transmitted and received wirelessly in the WLAN, the use of bandwidth is restricted. Hereinafter, an AP that provides the broadcasting service will be described with reference to FIG. 2.

FIG. 2 is a schematic block diagram of a general AP. As shown, the AP that receives a broadcast signal generally includes an input interface unit 201, a broadcast switch 203, a wireless physical (PHY) unit 205, and a zapping controller 207.

The input interface unit 201 receives a general broadcast signal from the broadcast network or the Internet. The input interface unit 201 outputs the received broadcast signal to the broadcast switch 203.

The broadcast switch 203 selectively receives a broadcast signal from the input interface unit 201 using a zapping protocol and transmits the received broadcast signal to the wireless PHY unit 205.

The wireless PHY unit 205 transmits the received broadcast signal to terminals via an antenna. The wireless PHY unit 205 receives a broadcast request signal from the terminals and transmits the received broadcast request signal to the zapping controller 207.

The zapping controller 207 transmits the received broadcast signal to the wireless PHY unit 205 using the zapping protocol for each user. The bandwidth of a broadcast signal received using the AP will now be described with reference to FIG. 3.

FIG. 3 is a graph illustrating a bandwidth and a broadcast signal that are provided in a general WLAN.

Referring to FIG. 3, the bandwidth that can be serviced in the AP of the WLAN and the bandwidth of a broadcasting service having a variable bit rate are shown. The broadcast signal requires a bandwidth that is larger than an available bandwidth for transmission from the WLAN to a user terminal, thus resulting in a loss of the broadcast signal. Wireless transmission of the WLAN uses limited resources and experiences a significant resource change when compared to wired transmission, making transmission of a broadcast signal difficult. Moreover, in the WLAN, the number of terminals that can be connected to a single AP is limited and the QoS of a broadcast signal is not ensured.

To solve the above problem, bandwidth monitoring and translating have been suggested. However, when using bandwidth monitoring and translating methods, a high response speed is required to monitor a real-time broadcasting service, but their implementation is not easy due to complex configurations and algorithms. Further, high costs are required for such implementation.

### SUMMARY OF THE INVENTION

One aspect of the present invention is to provide an AP for ensuring the QoS of a broadcasting service in a WLAN.

It is another aspect of the present invention to provide an AP having a simple structure for providing a broadcasting service from a WLAN to a plurality of terminals while ensuring the QoS of the broadcasting service.

In one embodiment, there is provided an access point (AP) for ensuring a Quality of Service (QoS) of a broadcasting service in a Wireless Local Area Network (WLAN). The AP includes a broadcast signal input unit, a broadcast signal control unit, a broadcast signal switching unit, and a broadcast signal output unit. The broadcast signal input unit receives a broadcast signal and depacketizes the received broadcast signal into a transport stream. The broadcast signal control unit receives channel selection information of a terminal, creates a zapping signal (protocol) and a control signal using bandwidth information to control a broadcast signal, and receives the broadcast signal. The broadcast signal switching unit receives the zapping signal and the control signal, selectively receives the transport stream using the zapping signal, stores the received transport stream for a predetermined amount of time, and outputs the stored transport stream to the broadcast signal control unit through time slicing using the control signal. The broadcast signal output unit receives a broadcast request signal from a terminal, transmits the received broadcast request signal to the broadcast signal control unit, and wirelessly services the broadcast signal of the broadcast signal control unit to the terminal.

### BRIEF DESCRIPTION OF THE DRAWINGS

The above features and advantages of the present invention will become more apparent from the following detailed description when taken in conjunction with the accompanying drawings in which:

FIG. 1 schematically illustrates a general WLAN;

FIG. 2 is a schematic block diagram of a general AP;

FIG. 3 is a graph illustrating a bandwidth and a broadcast signal that are provided in a general WLAN;

FIG. 4 is a schematic block diagram of an AP of a WLAN according to an embodiment of the present invention; and

FIG. 5 is a graph illustrating a broadcast signal with respect to a bandwidth of an AP for ensuring the QoS of the broadcast signal according to an embodiment of the present invention.

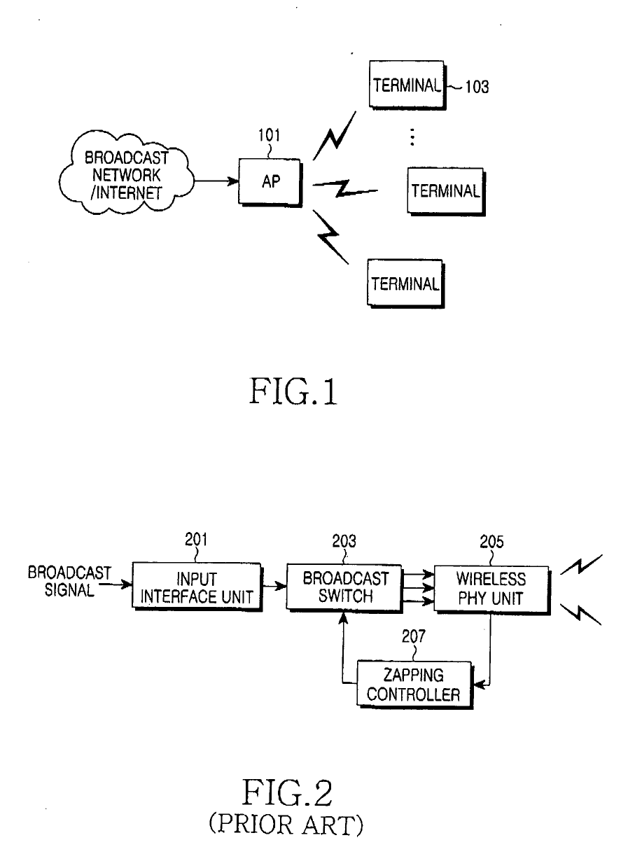

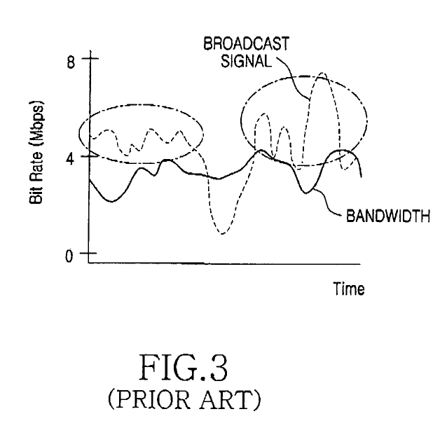

### DETAILED DESCRIPTION

Now, embodiments of the present invention will be described in detail with reference to the annexed drawings. For the purposes of clarity and simplicity, a detailed description of known functions and configurations incorporated herein has been omitted for conciseness.

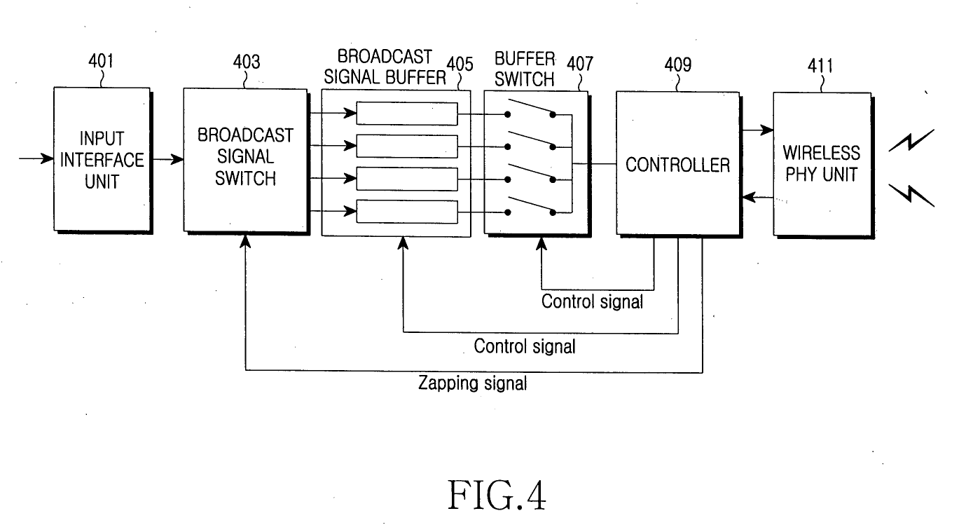

FIG. 4 is a schematic block diagram of an AP in a WLAN according to an embodiment of the present invention. As shown, the AP includes a broadcast signal input unit having an input interface unit 401, a broadcast signal switching unit having a broadcast signal switch 403, a broadcast signal buffer 405, a buffer switch 407, a broadcast signal control unit having a controller 409, and a broadcast signal output unit having a wireless PHY unit 411.

The AP that shares a network with a wired LAN connects to an external network such as a broadcast network or the Internet via a transmission medium such as a satellite, a ground wave, or a cable. The input interface unit 401 receives a broadcast signal from the broadcast network or the Internet. The input interface unit 401 is configured using, for example, a broadcast network interface such as a satellite, a ground wave, or a cable and an Asynchronous Serial Interface (ASI) that does not perform synchronization in broadcast signal transmission. The input interface unit 401 receives the broadcast signal, depacketizes the received broadcast signal into a Transport Stream (TS), and outputs the TS to the broadcast switch 403.

The broadcast switch 403 selectively receives a TS using a zapping protocol (signal) received from the controller 409 and transmits the received TS to the broadcast signal buffer 405. The TS is selected according to a broadcast channel using the zapping protocol. The broadcast switch 403 can be implemented using, for example, a Field Programmable Gate Array (FPGA).

The broadcast signal buffer 405 that receives the TS from the broadcast switch 403 selectively accumulates, i.e., stores, the received TS in a corresponding buffer included in the broadcast signal buffer 405. The broadcast signal buffer 405 has a variable size and actively assigns the size to each of buffers included therein according to a control signal from the controller 409. The size assigned to each of the buffers is determined by the transmission speed of the received TS and the resource assignment of time slicing. When using the broadcast signal buffer 405 according to the present invention, it is possible to solve the jitter problem of the received broadcast signal and ensure the QoS of the received broadcast signal regardless of a change in the bandwidth by storing the received broadcast signal for a predetermined amount of time and then transmitting the stored broadcast signal using a larger bandwidth.

The buffer switch 407 provides a time slicing function using an output signal of the broadcast signal buffer 405. The buffer switch 407 receives a control signal from the controller 409 and transmits a TS, which is stored in a corresponding buffer of the broadcast signal buffer 405 for a predetermined amount of time, i.e., broadcast data, to the controller 409.

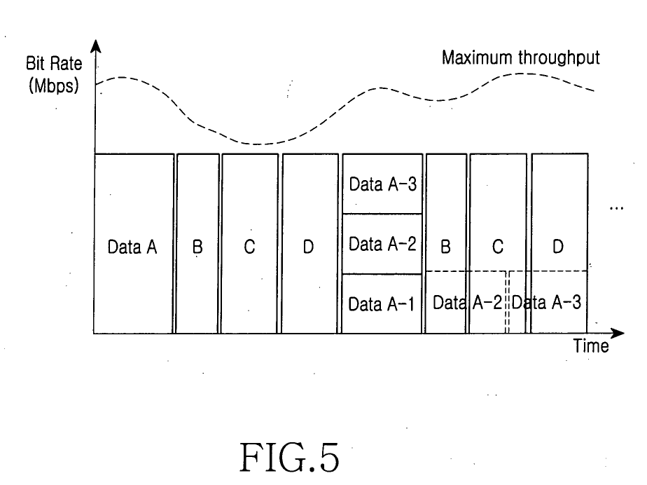

The controller 409 receives the broadcast data and transmits the received broadcast data to the wireless PHY unit 411. The controller 409 assigns a bandwidth desired by each terminal, i.e., a resource, to each terminal through time slicing. For the purpose of explanation, it is assumed that the AP provides a broadcasting service to a terminal 1 and a terminal 2. When a bandwidth of broadcast data desired by the terminal 1 is 20 Mbps and a bandwidth of broadcast data desired by the terminal 2 is 10 Mbps, the controller 409 sets the amount of time required for transmission of the terminal 1 two times larger than that of the terminal 2. Herein, the amount of time is calculated proportionally to a maximum bandwidth provided by the wireless PHY unit 411. The average of maximum bandwidths of the wireless PHY unit 411 may be set in the controller 409 or a maximum bandwidth transmitted from the wireless PHY unit 411 may be used. Setting the amount of time according to a bandwidth will be described later in detail with reference to FIG. 5.

The controller 409 transmits the zapping signal to the broadcast signal switch 403 to control the broadcast signal. The controller 409 controls the broadcast signal buffer 405 and the buffer switch 407 using the control signal. Thus, channel information desired by a terminal is received and a broadcast signal is selectively transmitted to the terminal using the control signal. Herein, the control signal input to the broadcast signal buffer 405 and the broadcast switch 407 is created using the maximum bandwidth of the wireless PHY unit 411 and bandwidth information for each user.

The wireless PHY unit 411 may apply a wireless PHY that adopts the concept of a channel and divides a bandwidth to accommodate a plurality of subscribers. Moreover, in the present invention, a Multiple Input Multiple Output (MIMO) technique is applied to the wireless PHY unit 411. For the purpose of illustration, a wireless PHY having 12 802.11a channels in a WLAN will be taken as an example. Thus, by applying the MIMO technique to the wireless PHY, 10 802.11a channels among the 12 802.11a channels can be grouped and the wireless PHY can provide each terminal with a bandwidth that is sufficiently large for broadcast signal transmission. Thus, the wireless PHY unit 411 transmits a broadcast signal to each terminal, receives a broadcast request signal from each terminal, and transmits the received broadcast request signal to the controller 409.

FIG. 5 is a graph illustrating a broadcast signal with respect to a bandwidth of the AP for ensuring the QoS of the broadcast signal according to an embodiment of the present invention.

Referring to FIG. 5, a broadcast signal according to a maximum bandwidth provided by the wireless PHY unit 411, i.e., broadcast data, is shown. In the case of broadcast data A, for a broadcasting service, data A-1, data A-2, and data A-3 are not separately transmitted, but instead they are stored in a corresponding buffer and then transmitted at a specified time. In addition, as described above, when the bandwidth of broadcast data desired by the terminal 1 is 20 Mbps and the bandwidth of broadcast data desired by the terminal 2 is 10 Mbps, the amount of time required for transmission of the broadcast data A is two times larger than that of broadcast data B. Thus, it is possible for the AP to efficiently manage a bandwidth provided to terminals.

The terminal can check the header of received data and extract only desired data. A broadcast stream is received by a predetermined buffer and only a signal requested by the terminal is selected and reproduced, thereby seamlessly transmitting a broadcast signal. When the terminal transmits a broadcast request signal, since the broadcast request signal does not have a large size, a plurality of terminals shares a single channel and transmits broadcast request signals to the AP through the shared channel.

As described above, in a WLAN, an AP according to the present invention has a predetermined buffer that accumulates a broadcast signal and transmits the accumulated broadcast signal according to the bandwidth required for a terminal, thereby ensuring the QoS of a broadcasting service. In addition, it is possible to provide a broadcasting service from a WLAN to a plurality of terminals while ensuring the QoS of the broadcasting service. Moreover, by transmitting broadcast data using the AP according to the present invention, it is possible to avoid interference between a plurality of terminals, which usually occurs in channel assignment to the terminals.

While the invention has been shown and described with reference to certain preferred embodiments thereof, it will be understood by those skilled in the art that various changes in form and details may be made therein without departing from the spirit and scope of the invention.

What is claimed is:

1. An access point (AP) for ensuring the Quality of Service (QoS) of a broadcasting service in a Wireless Local Area Network (WLAN), comprising:
a broadcast signal input unit for receiving a broadcast signal and depacketizing the received broadcast signal into a transport stream;
a broadcast signal control unit for receiving a channel selection information from a terminal and generating a zapping protocol signal and a control signal using bandwidth information to control the broadcast signal;
a broadcast signal switching unit for selectively receiving the transport stream according to the zapping signal, storing the received transport stream for a predetermined time period, and transmitting the stored transport stream to the broadcast signal control unit, via time slicing, according to the control signal; and
a broadcast signal output unit for receiving a broadcast request signal from the terminal, transmitting the received broadcast request signal to the broadcast signal control unit, and wirelessly servicing the broadcast signal from the broadcast signal control unit to the terminal.

2. The AP of claim 1, wherein the broadcast signal input unit comprises an input interface unit, coupled to one of a broadcast network and Internet, for depacketizing the received broadcast signal.

3. The AP of claim 1, wherein the broadcast signal switching unit comprises:
a broadcast signal switch for selectively receiving the transport stream according to the zapping signal;
a broadcast signal buffer for storing the selectively received transport stream in a corresponding buffer according to the control signal; and
a buffer switch for applying the time slicing to an output signal of the broadcast signal buffer according to the control signal.

4. The AP of claim 3, wherein the broadcast signal buffer having a plurality of different size buffers configured to assign the selectively received transport stream to one of the plurality of buffer according to the control signal.

5. The AP of claim 1, wherein the broadcast signal control unit comprises a controller for receiving the channel selection information of the terminal, generating the zapping signal and the control signal using maximum bandwidth information provided from the broadcast signal output unit to the terminal and for transmitting the zapping signal and the control signal to the broadcast signal switching unit to control the broadcast signal.

6. The AP of claim 5, wherein the control signal defines an amount of time required for transmission to the terminal in response to the maximum bandwidth information of the terminal.

7. The AP of claim 1, wherein the broadcast signal output unit comprises a wireless physical (PHY) unit for transmitting available bandwidth information and a broadcast request signal received from the terminal to the broadcast signal control unit and for wirelessly servicing an output signal of the broadcast signal control unit to the terminal.

8. The AP of claim 7, wherein the wireless PHY unit provides the broadcasting service to the terminal using a multiple input multiple input (MIMO) scheme.

9. The AP of claim 1, wherein the broadcast signal switching unit comprises a Field Programmable Gate Array (FPGA).

10. The AP of claim 1, wherein the broadcast signal switching unit is further configured to transmit the stored transport stream to the broadcast signal control unit at a larger bandwidth.

11. The AP of claim 7, wherein the wireless PHY unit uses a Multiple Input Multiple Output (MIMO) technique.
